(19) United States
(12) Patent Application Publication
(10) Pub. No.: US 2020/0078895 A1
(43) Pub. Date: Mar. 12, 2020

(54) COOLANT SUPPLY DEVICE

(71) Applicant: SUMITOMO PRECISION PRODUCTS CO., LTD., Hyogo (JP)

(72) Inventor: Tsunehiro TAKEUCHI, Hyogo (JP)

(21) Appl. No.: 16/563,845

(22) Filed: Sep. 7, 2019

(30) Foreign Application Priority Data
Sep. 12, 2018 (JP) 2018-170953

(51) Int. Cl. B23Q 11/10; B23Q 11/12; B01D 21/26

(52) U.S. Cl. CPC B23Q 11/1069; B01D 21/267; B23Q 11/126

(57) ABSTRACT

A coolant supply device includes a supply pump configured to supply a coolant of a clean tank to a machine tool, a recovering route configured to return the coolant from the machine tool to a dirty tank, a cyclone filter arranged on a coupling route and configured to separate the coolant into dirty liquid and a clean liquid, and a container connected to a dirty liquid outlet of the filter and configured to accumulate the sludge. The coolant supply device further includes a sensing unit configured to sense the amount of accumulation of the sludge in the container, and a controller configured to perform control based on a sensing result of the sensing unit.

### CROSS-REFERENCE TO RELATED APPLICATION

This application claims priority to Japanese Patent Application No. 2018-170953 filed on Sep. 12, 2018, the entire disclosure of which is incorporated by reference herein.

### BACKGROUND

The technique disclosed herein relates to a coolant supply device.

U.S. Pat. No. 6,162,355 describes a coolant supply device of a machine tool. This coolant supply device includes a cyclone filter, a first pump, and a second pump. The cyclone filter separates a coolant into clean liquid and dirty liquid. The first pump supplies the coolant from a tank configured to store the coolant to the cyclone filter. The second pump supplies the clean liquid separated by the cyclone filter to the machine tool. Moreover, the coolant supply device includes a recovering pipe for returning the coolant from the machine tool to the above-described tank. Further, the coolant supply device includes a dirty liquid return pipe for returning the dirty liquid separated by the cyclone filter to the above-described tank.

In the coolant supply device described in the above-described publication, the dirty liquid separated by the cyclone filter directly returns to the tank through the dirty liquid return pipe. There is a disadvantage that in this coolant supply device, sludge containing, e.g., chips caused at the machine tool are gradually accumulated in the tank.

For this reason, a container may be attached to a dirty liquid discharge outlet of the cyclone filter such that the sludge is accumulated in the container.

However, when the sludge is accumulated in the container, the sludge needs to be manually discharged from the container. A user needs to check the amount of accumulation of the sludge in the container on regular basis, leading to complexity. Moreover, when such a process relies on manual work, there is a probability that a checking process is ignored.

### SUMMARY

The technique disclosed herein allows sensing of the amount of accumulation of sludge of dirty liquid separated by a cyclone filter in a container configured to accumulate the sludge in a coolant supply device.

Specifically, the technique disclosed herein relates to a coolant supply device. This coolant supply device includes a supply pump configured to supply a coolant of a clean tank to a machine tool, a recovering route configured to return the coolant from the machine tool to a dirty tank, a cyclone filter arranged on a coupling route for sending the coolant from the dirty tank to the clean tank and configured to separate the coolant into dirty liquid containing sludge and clean liquid cleaner than the dirty liquid and discharge the clean liquid through an outlet connected to the clean tank, a container connected to a dirty liquid outlet of the filter and configured to accumulate the sludge, a sensing unit configured to sense the amount of accumulation of the sludge in the container, and a controller configured to perform control based on a sensing result of the sensing unit.

According to this configuration, the coolant supplied to the machine tool through the supply pump returns to the dirty tank through the recovering route. The coolant in the dirty tank contains chips, for example. While sending the coolant from the dirty tank to the clean tank, the cyclone filter separates the coolant into the dirty liquid containing the sludge and the clean liquid cleaner than the dirty liquid. The clean liquid is sent to the clean tank.

The container is connected to the dirty liquid outlet of the filter. The sludge in the dirty liquid is accumulated in the container. The coolant supply device does not return the dirty liquid separated by the filter to the dirty tank, and therefore, accumulation of the sludge in the dirty tank is reduced.

The sensing unit senses the amount of accumulation of the sludge in the container. A configuration of the sensing unit is not specifically limited, and various configurations can be employed. When the container is configured transparent so that the inside of the container can be viewed from the outside, the sensing unit may be, as one example, a camera configured to capture an image of the sludge accumulated in the container. A boundary between the accumulated sludge and the coolant can be specified based on the image captured by the camera, and therefore, the amount of accumulation of the sludge in the container can be sensed.

The sensing unit senses the amount of accumulation of the sludge in the container, and therefore, it is not necessary for a user to check the sludge accumulation amount on regular basis. Moreover, ignorance of the process of checking the sludge accumulation amount is reduced.

The controller can execute various types of control based on the sensing result of the sensing unit.

When the sludge accumulation amount exceeds a threshold, the controller may inform the user of such a state through an informing unit.

The user recognizes that the sludge is accumulated in the container, and therefore, the sludge in the container can be discarded.

When the sludge in the container is discarded, the coolant in the container is also discarded. In the above-described configuration, the sludge in the container is discarded when the sludge accumulation amount exceeds the threshold, and therefore, the frequency of discarding the sludge is low. As a result, the amount of the coolant to be discarded can be reduced.

The coolant supply device may include an on-off valve configured to open/close a discharge port for discharging the sludge from the container, and the controller may open/close the on-off valve when the sludge accumulation amount exceeds the threshold.

With this configuration, when the sludge is accumulated in the container, the controller automatically discards the sludge in the container. Excessive accumulation of the sludge in the container is reduced without the need for discarding the sludge by the user.

The controller may inform, based on a cycle in which the sludge accumulation amount exceeds the threshold, the user of the state through the informing unit.

When the machine tool repeats certain processing, a sludge accumulation speed is constant, and therefore, the cycle in which the sludge accumulation amount exceeds the threshold is also substantially constant. When the above-described cycle becomes shorter, there is a probability that an abnormality such as an increase in the amount of chips or failure in filtration on an upstream side of the cyclone filter has occurred.

The controller informs the user of the state based on the cycle in which the sludge accumulation amount exceeds the threshold, and therefore, the user can find failure in the coolant supply device or the machine tool at an earlier stage.

Specifically, the controller may predict, based on the cycle, timing at which the sludge accumulation amount exceeds the threshold, and may inform the user of the timing.

Based on the cycle in which the sludge accumulation amount exceeds the threshold, the controller can predict the future timing at which the sludge accumulation amount exceeds the threshold. The controller informs the user of the timing in advance, and therefore, the user can recognize the timing of discarding the sludge in the container.

When the sludge accumulation amount exceeds the threshold within predetermined time shorter than the cycle, the controller may inform, as another configuration example, the user of such a state.

When the time until the sludge accumulation amount exceeds the threshold becomes extremely shorter than the above-described cycle, there is a probability that the abnormality such as an increase in the amount of chips or failure in filtration on the upstream side of the cyclone filter has occurred. The controller informs the user of the state, and therefore, the user can promptly recognize occurrence of the abnormality.

The controller may inform, based on the sludge accumulation speed, the user of the state through the informing unit.

The sludge accumulation speed can be defined as the increment of the sludge accumulation amount in association with time. For example, when the sludge accumulation speed is too fast, there is a probability that some kind of abnormality has occurred. The controller informs the user of the state based on the sludge accumulation speed, and therefore, the user can find failure of the coolant supply device or the machine tool at an earlier stage.

### BRIEF DESCRIPTION OF THE DRAWINGS

FIG. 1 is a circuit diagram of an example configuration of a coolant supply device.

FIG. 2 is a view of an example configuration of a sensing unit including a camera configured to capture an image of sludge accumulated in a container.

FIG. 3 is a graph for describing a change in a sludge accumulation amount.

FIG. 4 is a flowchart executed by a controller in association with sludge accumulation.

### DETAILED DESCRIPTION

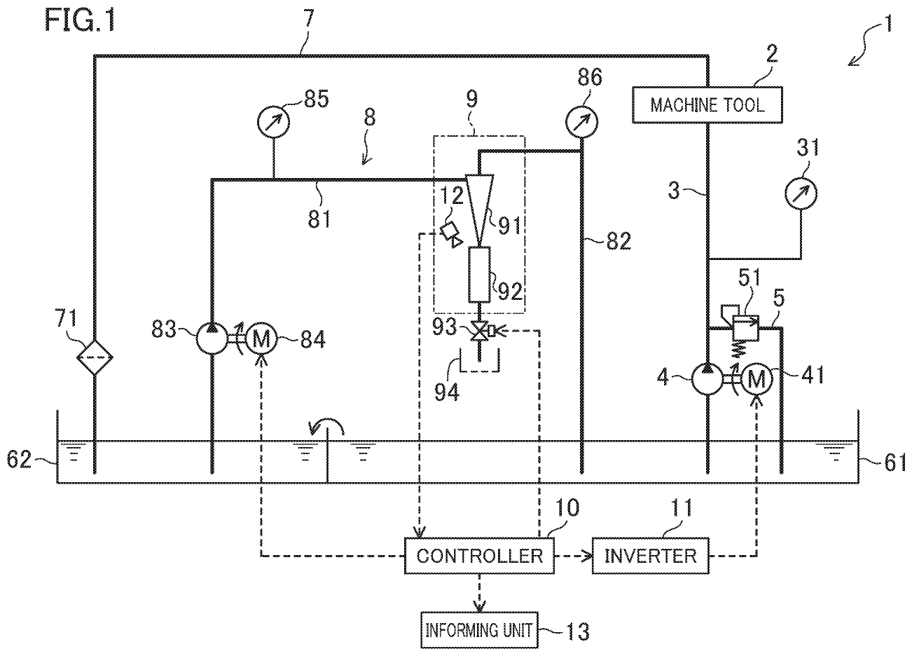

Hereinafter, an embodiment of a coolant supply device will be described in detail with reference to the drawings. Description below is one example of the coolant supply device. FIG. 1 illustrates an entire configuration of a coolant supply device 1 by way of example.

(Entire Configuration of Coolant Supply Device)

The coolant supply device 1 supplies a coolant to a tool (not shown) of a machine tool 2. The tool may be of any type. A hole for spraying the coolant is formed at the tool. The coolant is sprayed to a processing portion through such a hole.

A coolant supply route 3 is connected to the machine tool 2. A supply pump 4 is arranged at the supply route 3. The supply pump 4 sends a coolant of a clean tank 61 to the machine tool 2. Specifically, the supply pump 4 may be a rotary pump such as a gear pump, a vane pump, or a screw pump. Alternatively, the supply pump 4 may be a reciprocating pump such as a piston pump or a plunger pump. Note that the form of the pump is not limited.

An electric motor 41 is coupled to the supply pump 4. The electric motor 41 may be, for example, a rated torque type induction motor, a PM motor (a permanent magnet motor), or an induction motor.

The electric motor 41 can change a rotation speed according to a rotation speed command from an inverter 11. The inverter 11 outputs the rotation speed command to the electric motor 41.

A controller 10 is connected to the inverter 11. The controller 10 controls rotation of the electric motor 41 through the inverter 11.

A relief route 5 is connected to between the machine tool 2 and the supply pump 4 at the supply route 3. A relief valve 51 is arranged at the relief route 5. The relief valve 51 is configured to open with a predetermined pressure. The pressure for opening the relief valve 51 corresponds to the pressure (i.e., the set pressure) of the coolant supplied to the machine tool 2. The relief valve 51 is opened with the set pressure such that the pressure of the coolant supplied to the machine tool 2 is maintained at a certain pressure.

The relief route 5 is connected to the clean tank 61. An extra coolant flowing in the relief route 5 returns to the clean tank 61. Note that a first pressure gauge 31 indicating the pressure of the coolant is connected to the supply route 3.

A recovering route 7 for recovering the coolant is connected to the machine tool 2. A dirty tank 62 is connected to the recovering route 7. A primary filter 71 is interposed at the recovering route 7. The primary filter 71 separates a great foreign substance such as a chip from the coolant. Although a configuration of the primary filter 71 is not specifically limited, the primary filter 71 may include a return filter, for example.

The clean tank 61 and the dirty tank 62 are adjacent to each other in the configuration example of FIG. 1. As indicated by an arrow in FIG. 1, it is configured such that the coolant having overflowed from the clean tank 61 enters the dirty tank 62.

A coupling route 8 is provided between the dirty tank 62 and the clean tank 61. The coupling route 8 sends the coolant from the dirty tank 62 to the clean tank 61. A cyclone filter (hereinafter referred to as a “secondary filter”) 9 is interposed at the coupling route 8. The secondary filter 9 separates the coolant of the dirty tank 62 into dirty liquid containing sludge and clean liquid being cleaner than the dirty liquid containing no sludge or almost no sludge. The coupling route 8 is divided into an upstream coupling route 81 upstream of the secondary filter 9 and a downstream coupling route 82 downstream of the secondary filter 9.

A return pump 83 is arranged at the upstream coupling route 81. The return pump 83 returns the coolant of the dirty tank 62 to the secondary filter 9. The return pump 83 is also a constant-capacity positive-displacement pump. Specifically, the return pump 83 may be a rotary pump such as a gear pump, a vane pump, or a screw pump. Alternatively, the return pump 83 may be a reciprocating pump such as a piston pump or a plunger pump. Note that the form of the pump is not limited. An electric motor 84 is coupled to the return pump 83. The electric motor 84 is controlled by the controller 10. Note that a second pressure gauge 85 indicating the pressure of the coolant is connected to the upstream coupling route 81.

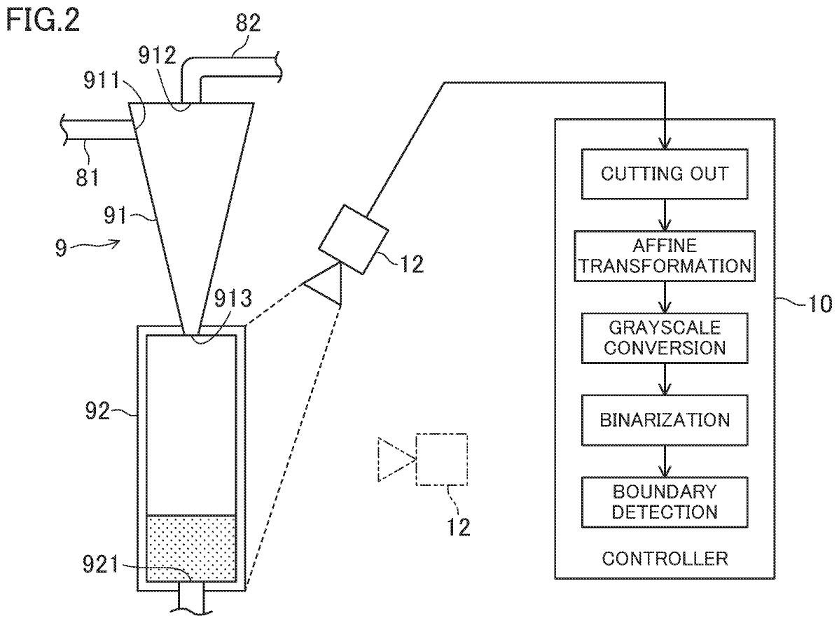

The secondary filter 9 is the cyclone filter as described above. As illustrated in FIG. 2, the secondary filter 9 includes a main body portion 91 and a first container 92 connected to the main body portion 91.

As schematically illustrated in FIG. 2, the main body portion 91 of the secondary filter 9 has a substantially downwardly-narrowed conical shape. The main body portion 91 has an inlet 911 connected to the upstream coupling route 81, a first outlet 912 for discharging the clean liquid, and a second outlet 913 for discharging the dirty liquid. The inlet 911 opens at a side surface of an upper portion of the main body portion 91, the first outlet 912 opens at an upper end portion of the main body portion 91, and the second outlet 913 opens at a lower end portion of the main body portion 91. The main body portion 91 turns the coolant supplied by the return pump 83 to discharge the clean liquid through the first outlet 912 and to discharge the dirty liquid containing the sludge through the second outlet 913.

The downstream coupling route 82 is connected to the first outlet 912. As illustrated in FIG. 1, the downstream coupling route 82 is connected to the clean tank 61. The clean liquid separated in the main body portion 91 of the secondary filter 9 enters the clean tank 61 through the first outlet 912 and the downstream coupling route 82. Note that a third pressure gauge 86 indicating the pressure of the coolant is connected to the downstream coupling route 82.

The first container 92 is connected to the second outlet 913. The first container 92 and the main body portion 91 are connected to each other. The first container 92 has a tubular shape. The first container 92 has a shape elongated in an upper-to-lower direction. The shape and size of the first container 92 can be set to optional shape and size.

An upper end of the first container 92 is connected to the second outlet 913 of the main body portion 91. A discharge port 921 is provided at a lower end of the first container 92. An on-off valve 93 is attached to the discharge port 921 (see FIG. 1). When the on-off valve 93 is closed, discharging of the dirty liquid through the discharge port 921 is inhibited. When the on-off valve 93 is closed, the sludge is accumulated in the first container 92. When the on-off valve 93 is opened, the dirty liquid is discharged through the discharge port 921. When the on-off valve 93 is opened, the sludge accumulated in the first container 92 is, together with the dirty liquid, discharged from the first container 92. As described later, the on-off valve 93 is opened/closed by the controller 10.

The first container 92 described herein is made of a transparent material. Thus, accumulation of the sludge in the first container 92 and the amount of accumulation of the sludge (i.e., the height of accumulation) can be viewed from the outside of the first container 92.

As illustrated in FIG. 1, a second container 94 is arranged on a lower side of the on-off valve 93. The second container 94 is configured to receive the sludge discharged from the first container 92. A filter is provided at the bottom of the second container 94. The filter prevents passage of the sludge, and allows passage of the coolant. The coolant having passed through the filter of the second container 94 enters the clean tank 61.

As described above, the controller 10 outputs a control signal to the inverter 11, the electric motor 84, and the on-off valve 93. Moreover, the controller 10 also outputs the control signal to an informing unit 13. The informing unit 13 may include a display device, for example. Alternatively, the informing unit 13 may include an output device configured to output sound or voice, for example. As another alternative, the informing unit 13 may include an informing lamp, for example.

(Configuration for Sensing Sludge Accumulation Amount)

The coolant supply device 1 includes a sensing unit configured to sense the sludge accumulated in the first container 92. Specifically, as illustrated in FIG. 1 or 2, the coolant supply device 1 includes a camera 12 configured to capture an image of the inside of the first container 92 made of the transparent material from the outside. The camera 12 is one example of the sensing unit. The camera 12 may be a camera 12 configured to capture a still image. Alternatively, the camera 12 may be a camera 12 configured to capture a moving image. As indicated by a chain line in FIG. 2, the camera 12 may be arranged facing the first container 92 in the horizontal direction. As indicated by a solid line in FIG. 2, the camera 12 may be arranged at an angle with respect to the first container 92. Such arrangement allows saving of an installation space of the camera 12. Note that as described later, the controller 10 performs various types of processing for the image captured by the camera 12, and in this manner, can accurately sense the amount of accumulation of the sludge in the first container 92 based on the image captured by the camera 12 regardless of the arrangement position of the camera 12.

The image captured by the camera 12 is input to the controller 10. The controller 10 senses the amount of accumulation of the sludge in the first container 92 based on the image. Specifically, the controller 10 first cuts out an area where the first container 92 is present from the image captured by the camera 12. Since the position of the camera 12 is fixed, the coordinates of an area to be cut out by a person may be set in advance, and information on such coordinates may be stored in the controller 10.

Since the camera 12 is arranged at an angle with respect to the first container 92, the cutout image is in a trapezoidal shape. The controller 10 performs correction for the cutout image such that the cutout image is an image of the first container 92 as viewed from the horizontal direction. The image is converted from the trapezoidal shape into a rectangular shape.

Moreover, the controller 10 converts the image subjected to affine transformation into a grayscale, and binarizes the image according to a threshold regarding a brightness. The controller 10 may store a preset threshold. In the binarized image, a coolant portion is white, and a sludge portion is black. The controller 10 senses a boundary between the sludge and the coolant in the binarized image, thereby sensing the amount of accumulation of the sludge in the first container 92 (i.e., the height of accumulation of the sludge in the first container 92).

In addition to binarization of the image according to the preset threshold, various techniques can be employed as the technique of sensing the boundary between the sludge and the coolant in the image by the controller 10 as described herein.

For example, the threshold for binarization is not the fixed value, and the controller 10 may set the threshold for binarization based on distribution and/or dispersion of the brightness of each pixel in the image converted into the grayscale.

Alternatively, the controller 10 may sense, without performing image binarization, the boundary between the sludge and the coolant by separation of the image into a sludge region and a coolant region. That is, the sludge is positioned at a lower portion of the first container 92, and the coolant is positioned at an upper portion of the first container 92. Thus, the controller 10 can separate, based on the distribution and/or dispersion of the brightness of each pixel, the image converted into the grayscale into the sludge region and the coolant region. When the image is separated into the sludge region and the coolant region, the controller 10 can sense the boundary between the sludge and the coolant.

Alternatively, instead of converting the image into the grayscale, the controller 10 may reduce the dimension of color information of the image captured by the camera 12 to a predetermined color phase easily causing a difference when the boundary between the sludge and the coolant is set. After reduction of the dimension of the color information of the image, the controller 10 may binarize such an image, or separate such an image into the sludge region and the coolant region. For example, the controller 10 may vectorize each pixel of the image into height information and color phase information, and thereafter, may perform separation into the sludge region and the coolant region by means of a support vector machine (SVM).

In some cases, the boundary between the coolant and the sludge in the first container 92 is less noticeable by human eyes. Machine learning may be utilized for sensing the boundary between the coolant and the sludge. For example, the controller 10 may use many images captured in advance by the camera 12 and teacher data for which a person has determined the boundary between the coolant and the sludge for each image, thereby learning sensing of the boundary between the coolant and the sludge by machine learning (including deep learning).

Alternatively, the controller 10 may be perform machine learning using no teacher data.

Further, machine learning can be also utilized for cutting out of the above-described image and affine transformation for the above-described image. For example, when performing such machine learning that the image of the camera 12 arranged at an angle with respect to the first container 92 is taken as input and the image of the camera 12 arranged horizontally to the first container 92 is taken as output, the controller 10 can properly perform cutting out of the image and affine transformation for the image. As a result, it can be expected that the accuracy of sensing the amount of accumulation of the sludge based on the image of the camera 12 is enhanced. Note that the controller 10 may learn cutting out of the image and affine transformation for the image by machine learning using no teacher data.

Note that the order of each type of processing performed for the image is not limited to that illustrated in FIG. 2, and the order of each type of processing can be switched as necessary.

(Various Types of Control by Controller by means of Sensing of Sludge Accumulation Amount)

Based on the sludge accumulation amount sensed based on the image captured by the camera 12, the controller 10 opens the on-off valve 93 to discharge the sludge from the first container 92 when the accumulation amount exceeds the threshold. With this configuration, excessive accumulation of the sludge in the first container 92 is reduced without the need for discarding the sludge by a user. Moreover, since the controller 10 discards the sludge based on the sludge accumulation amount sensed based on the image captured by the camera 12, the sludge can be discarded at timing at which the sludge is sufficiently accumulated in the first container 92. The frequency of discharging the sludge is decreased.

The sludge discharged from the first container 92 enters the second container 94. The user needs to discard the sludge having entered the second container 94. When the frequency of discharging the sludge from the first container 92 is decreased, the frequency of discarding the sludge having entered the second container 94 by the user is also decreased.

The camera 12 captures the image of the first container 92 on regular basis. With this configuration, the controller 10 can acquire time-series data on the amount of accumulation of the sludge in the first container 92. The controller executes various types of control based on the time-series data on the accumulation amount.

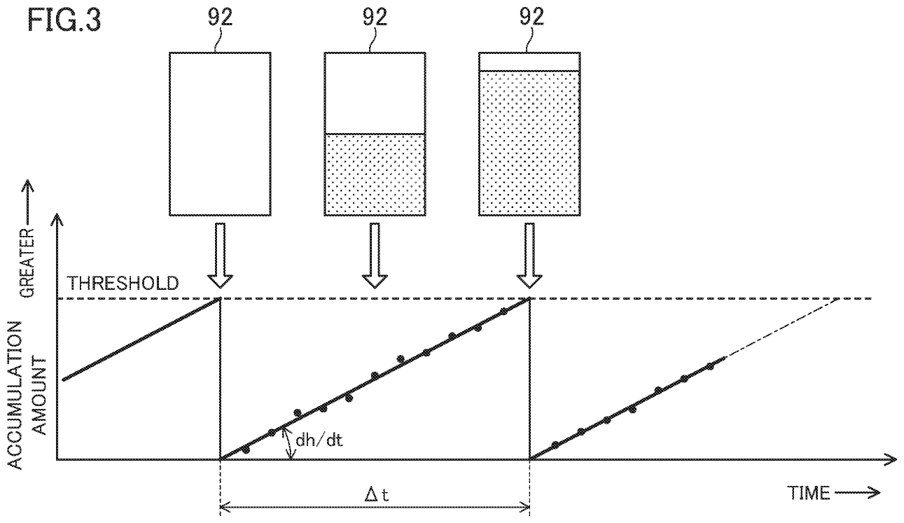

FIG. 3 illustrates, by way of example, a temporal change in the amount of accumulation of the sludge in the first container 92. The vertical axis of FIG. 3 is the sludge accumulation amount (or the height of accumulation in the first container 92). The horizontal axis of FIG. 3 is time, and the time progresses from the left to the right in the plane of paper of FIG. 3. When the machine tool 2 repeats certain processing, the speed (dh/dt) of accumulating the sludge in the first container 92 is substantially constant. When the sludge accumulation amount reaches the threshold, the controller 10 opens the on-off valve 93 to discard the sludge. The sludge accumulation amount reaches zero. By continuation of the processing of the machine tool 2, the sludge is accumulated again at the substantially constant speed (dh/dt), and therefore, a cycle Δt in which the sludge accumulation amount exceeds the threshold is substantially constant.

Based on the time-series data (see black circles in FIG. 3) on the sludge accumulation amount, the controller 10 acquires periodicity information by autocorrelation analysis using, e.g., an autoregressive (AR) model. The controller 10 can predict, from the acquired periodicity information, the next timing at which the sludge accumulation amount exceeds the threshold (see a chain line of FIG. 3). The controller 10 informs the user of the predicted timing through the informing unit 13.

When the cycle Δt becomes shorter, there is a probability that an abnormality occurs. For example, such an abnormality is occurrence of an abnormality such as an increase in the amount of chips in the machine tool 2 or failure in filtration by the primary filter 71 upstream of the secondary filter 9. The controller 10 determines, based on the time-series data on the sludge accumulation amount, whether or not the cycle Δt has become shorter. For example, when the sludge accumulation amount exceeds the threshold within shorter time than the cycle Δt by equal to or longer than predetermined time, the controller 10 may inform the user of such a state. The above-described “predetermined” time (or period) can be set to optional time.

Further, the controller 10 determines, based on the time-series data on the sludge accumulation amount, whether or not the sludge accumulation speed (dh/dt) is faster than a preset speed. This is because when the accumulation speed (dh/dt) is too fast, it is assumed that some kind of failure has occurred. Based on the accumulation speed, the controller 10 informs the user of the state, as necessary.

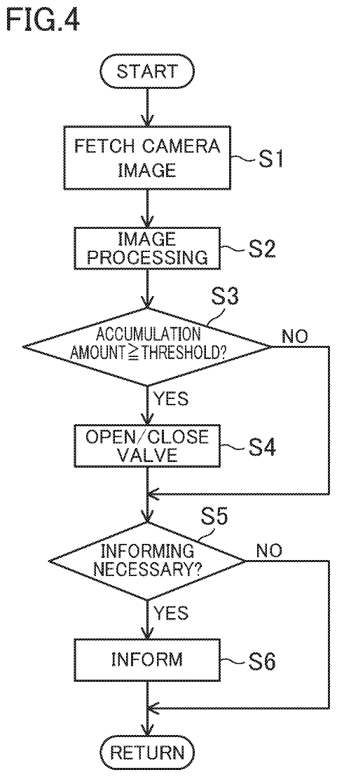

Next, the control executed by the controller 10 in association with sludge accumulation will be described with reference to FIG. 4. At a step S1, the controller 10 fetches the image captured by the camera 12. At a step S2, the controller 10 performs various types of processing for the fetched image. Specifically, as described above, the controller 10 cuts out the area where the first container 92 is present from the image, and performs affine transformation for the cutout image. Moreover, the controller 10 converts the image subjected to affine transformation into the grayscale, and executes binarization processing. Then, based on the image subjected to the processing, the controller 10 senses the amount of accumulation of the sludge in the first container 92 (see FIG. 2).

At a step S3, the controller 10 determines whether or not the amount of accumulation of the sludge in the first container 92 reaches equal to or greater than the threshold set in advance. When the sludge accumulation amount reaches equal to or greater than the threshold, the process proceeds to a step S4, and the controller 10 opens/closes the on-off valve 93. The controller 10 may use a timer to open the on-off valve 93 only at preset time. With this configuration, the sludge in the first container 92 can be discharged to the second container 94, and the amount of the coolant discharged from the first container 92 can be reduced. Note that the sludge in the second container 94 is discarded by the user.

When the amount of accumulation of the sludge in the first container 92 does not reach equal to or greater than the threshold, the process does not proceed to the step S4, but proceeds to a step S5. When the amount of accumulation of the sludge in the first container 92 is small, discharging of the sludge from the first container 92 is reduced. The frequency of discarding the sludge having entered the second container 94 by the user can be decreased.

At the step S5, the controller 10 determines whether or not informing is necessary. As described above, the controller 10 predicts the next timing at which the sludge accumulation amount exceeds the threshold, and when such timing is approaching, the controller 10 informs the user of such a state. Moreover, when the controller 10 determines that the cycle Δt in which the sludge accumulation amount exceeds the threshold has become shorter, the controller 10 informs the user of such a state. Further, when the controller 10 determines that the sludge accumulation speed is too fast, the controller 10 informs the user of such a state.

When determination at the step S5 is YES, the process proceeds to a step S6, and the controller 10 informs the user of the state through the informing unit 13. The controller 10 may display, for example, an indication on the display device to inform the user of the state, or may emit sound or voice to inform the user of the state. The user having received such information can notice the timing of discarding the sludge from the first container 92, and can find failure of coolant supply device 1 or the machine tool 2 at an earlier stage.

When determination at the step S5 is NO, the process does not proceed to the step S6, but returns.

Note that after the sludge has been discharged from the first container 92, the sludge is no longer present in the first container 92. Thus, the controller 10 can no longer sense the amount of accumulation of the sludge in the first container 92 based on the image of the camera 12, or it is difficult for the controller 10 to sense such an amount. For this reason, after the sludge has been discharged from the first container 92 at the step S4, the controller 10 does not necessarily sense the amount of accumulation of the sludge in the first container 92 based on the image of the camera 12 for a preset period.

Alternatively, the controller 10 may process the captured image of the first container 92 right after the sludge has been discharged from the first container 92 at the step S4. When the controller 10 determines, based on such an image, that the sludge is accumulated in the first container 92, it is assumed that the sludge adheres to an inner wall surface of the first container 92. The controller 10 may inform the user of such a state to prompt the user to wash the first container 92, for example.

Further, when the controller 10 determines that the amount of accumulation of the sludge in the first container 92 does not change for a long period of time, even if the sludge accumulation amount is not equal to or greater than the threshold, the controller 10 may open the on-off valve 93 to discharge the sludge from the first container 92. In this case, it is expected that some kind of failure has occurred, and therefore, the controller 10 may inform the user of such a state.

In the above-described configuration example, the controller 10 opens/closes the on-off valve 93, but the on-off valve 93 may be manually opened/closed. In this configuration, the controller 10 informs the user of the state at the step S4 of FIG. 4. The user having received the information can open/close the on-off valve 93 to discharge the sludge from the first container 92. Since the coolant supply device 1 includes the sensing unit, the user can discharge the sludge from the first container 92 at proper timing.

Moreover, the discharge port 921 of the first container 92 may be closed, and the on-off valve 93 may be omitted. In this configuration, the user having received the information can detach the first container 92 from the main body portion 91 to discard the sludge from the first container 92.

What is claimed is:

1. A coolant supply device comprising:
a supply pump configured to supply a coolant of a clean tank to a machine tool;
a recovering route configured to return the coolant from the machine tool to a dirty tank;
a cyclone filter arranged on a coupling route for sending the coolant from the dirty tank to the clean tank and configured to separate the coolant into dirty liquid containing sludge and clean liquid cleaner than the dirty liquid and discharge the clean liquid through an outlet connected to the clean tank;
a container connected to a dirty liquid outlet of the filter and configured to accumulate the sludge;
a sensing unit configured to sense an amount of accumulation of the sludge in the container; and
a controller configured to perform control based on a sensing result of the sensing unit.

2. The coolant supply device according to claim 1, wherein
when the sludge accumulation amount exceeds a threshold, the controller informs a user of such a state through an informing unit.

3. The coolant supply device according to claim 2, wherein
the controller informs, based on a cycle in which the sludge accumulation amount exceeds the threshold, the user of the state through the informing unit.

4. The coolant supply device according to claim 3, wherein
the controller predicts, based on the cycle, timing at which the sludge accumulation amount exceeds the threshold, and informs the user of the timing.

5. The coolant supply device according to claim 3, wherein
when the sludge accumulation amount exceeds the threshold within predetermined time shorter than the cycle, the controller informs the user of such a state.

6. The coolant supply device according to claim 2, wherein
the controller informs, based on a sludge accumulation speed, the user of the state through the informing unit.

7. The coolant supply device according to claim 1, wherein
the container is transparent, and
the sensing unit is a camera configured to capture an image of the sludge accumulated in the container.
